(19) United States
(12) Patent Application Publication
(10) Pub. No.: US 2026/0032631 A1
(43) Pub. Date: Jan. 29, 2026

(54) METHOD FOR SENSING MEASUREMENT AND CHIP

(71) Applicant: GUANGDONG OPPO MOBILE TELECOMMUNICATIONS CORP., LTD., Dongguan (CN)

(72) Inventor: Yang LIU, Dongguan (CN)

(21) Appl. No.: 19/350,650

(22) Filed: Oct. 6, 2025

Related U.S. Application Data
(63) Continuation of application No. PCT/CN2023/099128, filed on Jun. 8, 2023.

(51) Int. Cl. H04W 64/00; H04W 72/0446; H04W 72/25

(52) U.S. Cl. CPC H04W 64/00; H04W 72/0446; H04W 72/25

(57) ABSTRACT

Provided is a method for sensing measurement, performed by a first terminal. The method includes: determining a first sidelink positioning reference signal (SL-PRS) associated with first association information, wherein at least two pieces of association information are associated with different SL-PRS configurations, and each of the at least two pieces of association information includes at least one of an area or a time window, and performing sensing measurement via the first SL-PRS based on the first association information.

### CROSS-REFERENCE TO RELATED APPLICATION

This application is a continuation of International Application No. PCT/CN2023/099128, filed Jun. 8, 2023, the entire disclosure of which is incorporated herein by reference.

### TECHNICAL FIELD

Embodiments of the present disclosure relate to the technical field of mobile communications, and in particular, relate to a method and apparatus for sensing measurement, and a chip therefor.

### RELATED ART

Wireless electromagnetic waves in cellular networks may be used in wireless data transmission and wireless communication, and also have environmental sensing capabilities to support implementation of sidelink (SL) sensing.

Regarding the sidelink sensing, a target terminal (target UE) measures a sidelink positioning reference signal (SL-PRS) transmitted by an anchor terminal (anchor UE) to acquire a sensing measurement result, and returns the measurement result to the anchor terminal, thereby completing wireless sensing.

In practice, a terminal (user equipment, UE) is mobile, and in a case where a movement distance of the terminal is greater than a predetermined threshold, the terminal is no longer able to detect a previously configured SL-PRS transmitted by an anchor terminal due to signal attenuation.

### SUMMARY

Embodiments of the present disclosure provide a method and apparatus for sensing measurement, and a device and a storage medium therefor.

According to some embodiments of the present disclosure, a method for sensing measurement is provided. The method is performed by a first terminal, and includes:
determining a first SL-PRS associated with first association information, wherein at least two pieces of association are associated with different SL-PRS configurations, and each of the at least two pieces of associated information include at least one of an area or a time window;
performing a sensing measurement via the first SL-PRS based on the first association information.

According to some embodiments of the present disclosure, a method for sensing measurement is provided. The method is performed by a network device, and includes:
configuring at least two pieces of association information for the first terminal with at least two sets of SL-PRS configurations corresponding to the at least two pieces of association information, wherein the at least two pieces of association information are associated with different SL-PRS configurations, and each of the at least two pieces of association information includes at least one of an area or a time window.

According to some embodiments of the present disclosure, a chip is provided. The chip includes programmable electric logic circuitry and/or one or more program instructions, and the chip, when running, is configured to determine a first SL-PRS associated with first association information, wherein at least two pieces of association are associated with different SL-PRS configurations, and each of the at least two pieces of associated information include at least one of an area or a time window; and perform a sensing measurement via the first SL-PRS based on the first association information.

### BRIEF DESCRIPTION OF DRAWINGS

For clearer descriptions of the technical solutions according to the embodiments of the present disclosure, the following briefly illustrates drawings required for the description of the embodiments. Obviously, the illustrated drawings below are only some embodiments of the present disclosure. For ordinary persons skilled in the art, other drawings may be obtained based on these drawings without the premise of creative labor

FIG. 1 is a schematic diagram of a network architecture according to some embodiments of the present disclosure;

FIG. 2 is a schematic diagram of a network architecture in a wireless sensing scenario according to some embodiments of the present disclosure;

FIG. 3 is a schematic diagram of a network architecture in a wireless sensing scenario based on a sidelink according to some embodiments of the present disclosure;

FIG. 4 is a schematic diagram of a network architecture in a wireless sensing scenario based on a sidelink according to some embodiments of the present disclosure;

FIG. 5 is a schematic diagram of a network architecture in a wireless sensing scenario based on a sidelink according to some embodiments of the present disclosure;

FIG. 6 is a schematic diagram of a network architecture in a wireless sensing scenario based on a sidelink according to some embodiments of the present disclosure;

FIG. 7 is a schematic flowchart of a method for sensing measurement according to some embodiments of the present disclosure;

FIG. 8 is a schematic flowchart of a method for sensing measurement according to some embodiments of the present disclosure;

FIG. 9 is a schematic flowchart of a method for sensing measurement according to some embodiments of the present disclosure;

FIG. 10 is a schematic flowchart of a method for sensing measurement according to some embodiments of the present disclosure;

FIG. 11 is a schematic flowchart of a method for sensing measurement according to some embodiments of the present disclosure;

FIG. 12 is a schematic flowchart of a method for sensing measurement according to some embodiments of the present disclosure;

FIG. 13 is a schematic flowchart of an apparatus for sensing measurement according to some embodiments of the present disclosure;

FIG. 14 is a schematic flowchart of an apparatus for sensing measurement according to some embodiments of the present disclosure; and

FIG. 15 is a schematic structural diagram of a terminal device according to some embodiments of the present disclosure.

### DETAILED DESCRIPTION

For clearer description of the objectives, technical solutions, and advantages of the present disclosure, the embodiments of the present disclosure are described in detail hereinafter in combination with the accompanying drawings. When the following description refers to the drawings, unless indicated otherwise, the same numerals in different drawings represent the same or similar elements. The implementations described in the following exemplary embodiments do not represent all implementations consistent with the present disclosure. Rather, the implementations are merely examples of devices and methods consistent with some aspects of the present disclosure as detailed in the appended claims.

The network architecture and service scenarios described in the embodiments of the present disclosure are intended to illustrate the technical solutions according to the embodiments of the present disclosure more clearly but do not limit the technical solutions. Those skilled in the art understand that with evolution of the network architecture and emergence of new service scenarios, the technical solutions according to the embodiments of the present disclosure are also applicable to addressing similar technical problems. The technical terms used in the present disclosure are merely intended to describe particular embodiments and do not limit the scope of the present disclosure. The singular forms of the terms “a,” “an,” and “the” used herein and in the appended claims include their plural forms as well unless the context clearly indicates otherwise. Furthermore, it should be understood that the term “and/or” used herein indicates and encompasses any and all possible combinations of one or a plurality of associated listed elements.

It should be understood that, although the terms “first,” “second,” “third,” and the like may be used herein to describe various information but are not intended to limit the information. These terms are merely used to distinguish one category of information from another. For instance, without leaving the scope of the present disclosure, a first parameter may be referred to as a second parameter, similarly, the second parameter may also be referred to as the first parameter. Depending on the context, the term “if” may be interpreted as “when” or “upon” or “in response to determining.”

Some of the terms involved in the embodiments of the present disclosure are described hereinafter.

The term “sensing” refers to using wireless electromagnetic waves to detect parameters of a physical environment in order to perform a technology capable of target positioning, motion recognition, imaging, sensing, and the like. Devices participating in sensing include: a sensing signal transmitter device or an anchor device, which is a device transmitting a sidelink parameter signal in the embodiments of the present disclosure; and a sensing signal receiver device, which is a device receiving and measuring a sidelink parameter signal in the embodiments of the present disclosure.

Some of the relevant technical background knowledge involved in the embodiments of the present disclosure is described hereinafter.

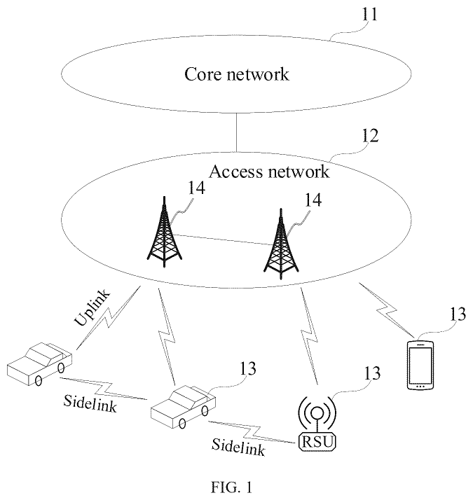

FIG. 1 is a schematic diagram of a network architecture according to some embodiments of the present disclosure. The network architecture may involve a core network 11, an access network 12, and a terminal 13.

The core network 11 includes a number of core network devices. The main function of the core network device is to provide user connectivity, user management, and to complete bearing of services, which operates as a gateway providing an interface to an external network. For example, a core network of the 5^{th} generation (5G) new radio (NR) technology system may include an access and mobility management function (AMF) entity, a user plane function (UPF) entity, a session management function (SMF) entity, and the like.

The access network 12 includes several access network devices 14. The access network in the 5G NR system may be referred to as a new generation-radio access network (NR-RAN). The access network device 14 is a type of apparatus deployed in the access network 12 to provide a wireless communication function to the terminal 13. The access network may include various forms of a macrocell station, a microcell station, a relay station, an access point, and the like. In a system using different wireless access technologies, the names of the devices possessing an access network function may vary, for instance, the devices are called 5G next generation Node B in the 5G NR system. The term “access network device” may vary with the evolution of communication technology. For ease of description herein, the embodiments of the present disclosure will collectively refer to the apparatus providing wireless communication function to the terminal 13 as the access network device.

Generally, a plurality of terminals 13 is provided, and one or more terminals 13 may be deployed within each cell managed by the access network device 14. The terminal 13 may include various handheld devices, vehicle-mounted equipment, wearable devices, computing devices or other devices connected to a wireless modem, as well as user equipments (UEs), mobile stations (MSs), and the like possessing wireless communication function. For ease of description, the devices are collectively referred to as the terminal. The access network device 14 and the core network device communicate with each other over some air interface technology, for instance, the NG interface in the 5G NR system. The access network device 14 and the terminal 13 communicate with each other over some air interface technology, for example, the Uu interface.

The terminals 13 (e.g., vehicle-mounted device and other device (e.g., other vehicle-mounted device, cellphone, road side unit, (RSU) and the like)) may communicate with each other over a direct communication interface (e.g., a ProSe communication (PC5) interface), accordingly, a communication link established based on the direct communication interface may be referred to as a direct link or sidelink (SL). SL transmission, known to directly perform communication data transmission between terminals over the sidelink, differs from a traditional cellular system in which communication data is transmitted or received over the access network device, SL transmission possesses characteristics such as low latency, minimal overhead, and the like, making it suitable for communication between two geographically proximate terminals (e.g., vehicle-mounted device and other geographically proximate devices). SL technology may be used in various scenarios where the direct communication between terminals is required, for example, the vehicle-to-vehicle communication in the V2X scenario. In other words, the terminal in the present disclosure refers to any type of device using SL technology for communication. 5G NR system in the embodiments of the present disclosure may also be referred to as a 5G system or a NR system, which should be understood by any person skilled in the art. The technical solutions described by the embodiments of the present disclosure may be suited for a 5G NR system and a future evolved system of the 5G NR system. The terms “UE” and “terminal” in the embodiments of the present disclosure have identical meaning and may be used interchangeably.

Since radio signals used by cellular networks are not only used for wireless data transmission and communication, but also have environmental sensing capabilities, for example, user motion or gesture recognition, respiration monitoring, terminal movement speed measurement, environment imaging, weather monitoring, and the like. Therefore, in future cellular networks, the radio signals are not only used for communication and data transmission, but also used for acquisition of sensing information.

At present, support for sensing capabilities beyond 5G networks is under discussion. By adding a sensing function (SF) element and a corresponding workflow in the 3GPP network, the sensing function may be supported. In a practical sensing scenario, sensing measurement may be categorized as active sensing or passive sensing depending on a sensing target. The sensing target of the active sensing is a UE, i.e., UE-level sensing; and the sensing target of the passive sensing is a target area or a target object, i.e., area-level sensing, and does not belong to the 3^{rd} Generation Partner Project (3GPP) without a specific UE.

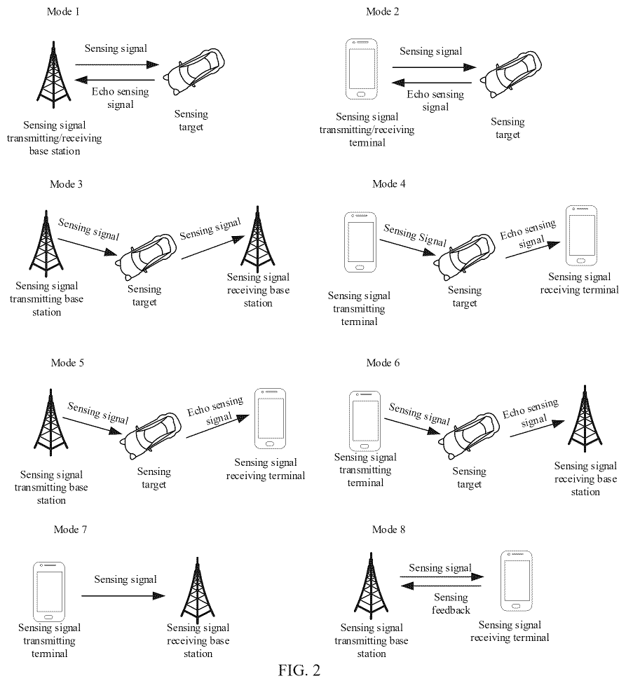

Under the tendency that the development of both the spectrum for wireless communication and the spectrum for sensing increasingly overlap, integrated sensing and communication combines both functions, and may use a wireless resource for the wireless communication to achieve a sensing function. As illustrated in FIG. 2, a scenario of the integrated sensing and communication includes at least one out of 8 modes.

Mode 1: Base station monostatic sensing. In Mode 1, the sensing signal transmitter device and the sensing signal receiver device are the same base station, i.e., the base station transmits a sensing signal to a sensing target, and the same base station receives an echo sensing (i.e., a sensing signal reflected by the sensing target) signal upon reflection of the sensing signal from the sensing target.

Mode 2: Terminal monostatic sensing. In Mode 2, the sensing signal transmitter device and the sensing signal receiver device are the same terminal, i.e., the terminal transmits the sensing signal to the sensing target, and the same terminal upon reflection of the sensing signal from the sensing target.

Mode 3: Base station collaborative sensing. In Mode 3, the sensing signal transmitter device and the sensing receiver device are different base stations, i.e., one base station transmits a sensing signal to a sensing target, and another base station receives the echo sensing signal upon reflection of the sensing signal from the sensing target.

Mode 4: Terminal collaborative sensing. In Mode 4, the sensing signal transmitter device and the sensing signal receiver device in Mode 4 are different terminals, i.e., one terminal transmits a sensing signal to a sensing target, and another terminal receives the echo sensing signal upon reflection of the sensing signal from the sensing target.

Mode 5: Base station-to-terminal collaborative sensing. In Mode 5, the sensing signal transmitter device is a base station, and the sensing signal receiver device is a terminal, i.e., the base station transmits the sensing signal to the sensing target, and the terminal receives the echo sensing signal upon reflection of the sensing signal from the sensing target.

Mode 6: Terminal-to-base station collaborative sensing. In Mode 6, the sensing signal transmitter device is a terminal, and the sensing receiver device is a base station, i.e., the terminal transmits the sensing signal to the sensing target, and the base station receives the echo sensing signal upon reflection of the sensing signal from the sensing target.

Mode 7: The sensing target is the sensing signal transmitter device. In Mode 7, the signal transmitter device is a terminal, and the sensing receiver device is a base station. As the sensing target is the sensing signal transmitter device (terminal), the sensing signal is transmitted by the sensing signal transmitter device (terminal) to the sensing signal receiver device (base station) and no reflection is required thereafter. Instead, the base station may directly parse a sensing result upon reception of the sensing signal.

Mode 8: The sensing target is the sensing signal receiver device. In Mode 8, the sensing signal transmitter device is the base station, while the sensing signal receiver device is the terminal. As the sensing target (UE) is the sensing signal receiver device, a sensing result needs to be fed back to the base station upon receiving the sensing signal by the terminal, and thus the base station may acknowledge the sensing result.

A method for sidelink sensing is as follows: a measurement is performed by an SL-PRS transmitted by a target UE to an anchor UE, acquiring a measurement result; and afterwards, the result is returned to the anchor UE, thereby completing a process of wireless sensing.

In practice, the UE is mobile, and in a case where a distance traveled by the terminal exceeds a predetermined threshold, the terminal is no longer able to detect the SL-PRS transmitted by the previously configured anchor terminal due to signal degradation.

Some of the related sensing scenarios are described hereinafter.

Communication-assisted sensing refers to target detection and estimation via communication signals transmitted by a base station or a UE to determine whether the target is present, and to estimate speed, distance, angle of arrive, and the like information thereof. The target may be a person or an object, and intrusion, movement, falling, pose recognition, 3D object reconstruction, and the like functions may be implemented. The sensing method according to the embodiments of the present disclosure is applicable to the following two sensing scenarios.

In a first sensing scenario, the sensing signal receiver device and the sensing target are moving in the same direction.

In at least two areas and/or time windows, at least two sensing signal receiver terminals are involved in sensing measurement. That is, in different areas and/or time windows, different sensing signal receiver terminals are involved in sensing measurement. In at least two areas and/or time windows, the SL-PRS configurations for sensing measurement are different.

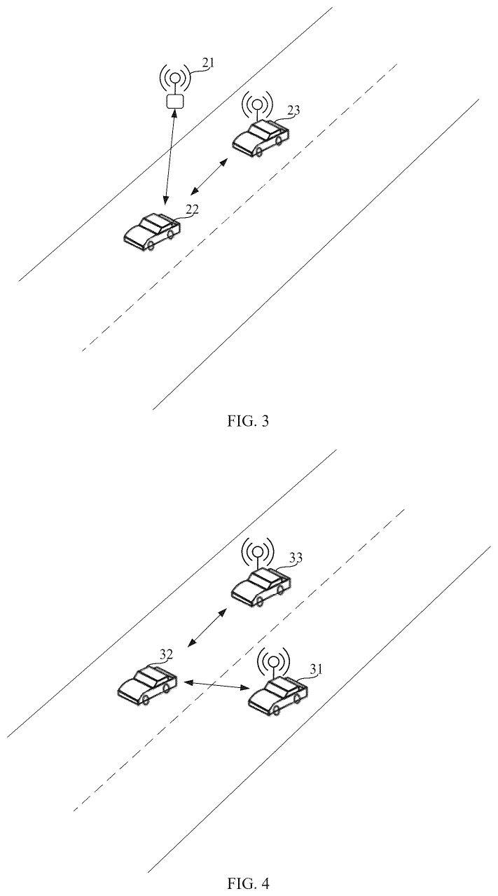

In some embodiments, a network architecture of the first sensing scenario is as illustrated in FIG. 3 and FIG. 4. In FIG. 3, an absolutely stationary sensing signal transmitter terminal 21 transmits an SL-PRS via a sidelink, a sensing signal receiver terminal 23 measures the SL-PRS, and senses a target 22 in the environment, and the target 22 and the sensing signal receiver terminal 23 move in the same direction. In FIG. 4, a mobile sensing signal transmitter terminal 33 measures the SL-PRS, and senses the target 22 in the environment, and the target 32 and the sensing signal receiver terminal 33 move in the same direction.

In a second sensing scenario, in different areas and/or time windows, the sensing signal receiver terminal performs sensing measurements for different targets.

Positions of the targets do not change, while a position of the sensing signal receiver terminal changes. The sensing signal receiver terminal performs sensing measurements for the different targets based on different SL-PRS configurations in the different areas and/or time windows.

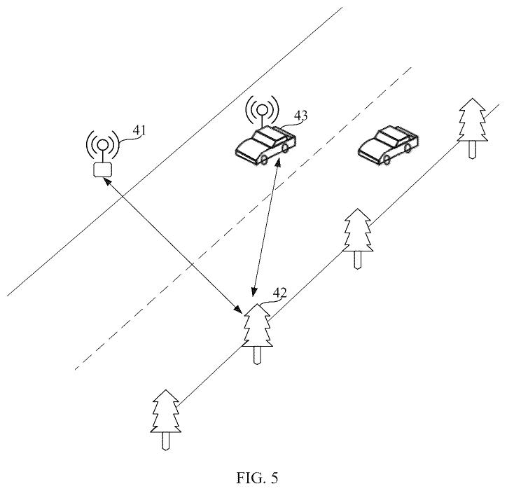

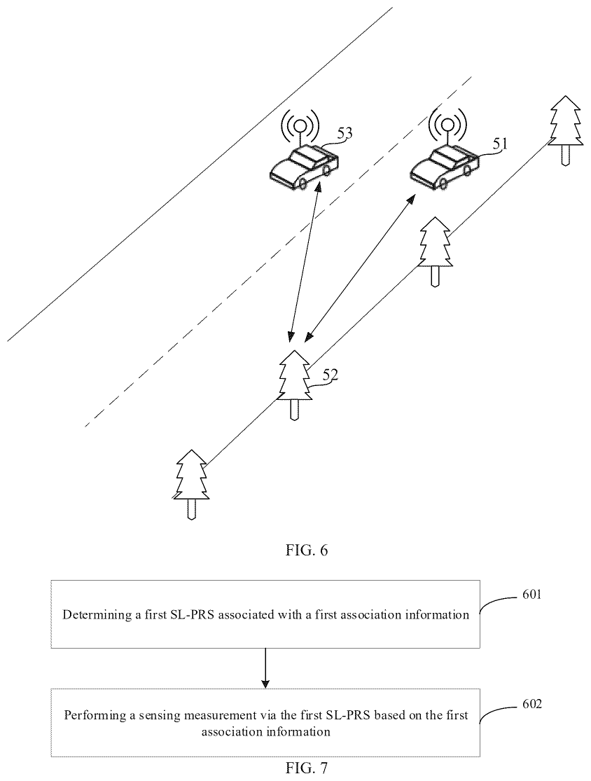

In some embodiments, a network architecture of the second sensing scenario is as illustrated in FIG. 5 and FIG. 6. In FIG. 5, a stationary sensing signal transmitter terminal 41 transmits an SL-PRS via a sidelink, a sensing signal receiver terminal 43 measures the SL-PRS, and senses an absolutely stationary target 42 in the environment. In FIG. 6, a mobile sensing signal transmitter terminal 51 transmits an SL-PRS, a sensing signal receiver terminal 53 measures the SL-PRS, and senses an absolutely stationary target 52 in the environment.

FIG. 7 is a schematic flow diagram of a method for sensing measurement according to some embodiments of the present disclosure. The method is performed a first terminal, and includes the following steps.

In step 601, the first terminal determines a first SL-PRS associated with first association information.

At least two pieces of association information are associated with different SL-PRS configurations, and each of at least two pieces of association information includes at least one of an area or a time window.

In some embodiments, each piece of association information in the at least two pieces of association information has a corresponding SL-PRS configuration, and it is impossible that different pieces of association information are associated with the same SL-PRS configuration.

In some embodiments, the at least two pieces of association information include first partial association information and second partial association information. The first partial association information contains different association information that are associated with the same SL-PRS configuration. The second partial association information has each piece of association information associated with the corresponding SL-PRS configuration, and it is impossible that different pieces of association information are associated with the same SL-PRS configuration.

The first terminal contains at least two pieces of association information, and different SL-PRS configurations associated with the at least two pieces of association information. The first terminal determines a first SL-PRS associated with first association information in the at least two pieces of association information. Exemplary, the first terminal determines an SL-PRS configuration associated with the first association information, and determines a first SL-PRS based on the SL-PRS configuration associated with the first association information. That is, the first terminal determines the first SL-PRS based on a first SL-PRS configuration associated with the first association information.

For example, the at least two pieces of association information include association information 1, association information 2, and association information 3, wherein the association information 1 is associated with an SL-PRS configuration 01, the association information 2 is associated with an SL-PRS configuration 02, and the association information 3 is associated with an SL-PRS configuration 03. Regarding the association information 1, the first terminal determines the SL-PRS configuration 01 associated with the association information 1, and determines an SL-PRS for sensing measurement based on the SL-PRS configuration 01. Regarding the association information 2, the first terminal determines the SL-PRS configuration 02 associated with the association information 2, and determines an SL-PRS for sensing measurement based on the SL-PRS configuration 02. Regarding the association information 3, the first terminal determines the SL-PRS configuration 03 associated with the association information 3, and determines an SL-PRS for sensing measurement based on the SL-PRS configuration 03

In some embodiments, the association information includes the area; wherein at least two areas are associated with different SL-PRS configurations. The first terminal contains at least two areas, and different SL-PRS configurations associated with the at least two areas, the first association information includes a first area; the first terminal determines the first SL-PRS associated with the first area in the at least two areas. Exemplary, the first terminal determines the SL-PRS configuration associated with the first area, and determines the first SL-PRS based on the SL-PRS configuration associated with the first area.

For example, the at least two areas include an area 1 and an area 2, wherein the area 1 is associated with an SL-PRS configuration 11, and the area 2 is associated with an SL-PRS configuration 12. Upon entering the area 1, the first terminal determines the SL-PRS configuration 11 associated with the area 1, and determines an SL-PRS based on the SL-PRS configuration 11. Upon entering the area 2, the first terminal determines the SL-PRS configuration 12 associated with the area 2, and determines an SL-PRS based on the SL-PRS configuration 12.

In some embodiments, the association information includes a time window; wherein at least two time windows are associated with different SL-PRS configurations. The first terminal contains at least two time windows, and different SL-PRSs associated with the at least two time windows; and the first association information includes a first time window. The first terminal determines the first SL-PRS associated with the first time window in the at least two time windows. Exemplary, the first terminal determines the SL-PRS configuration associated with the first time window, and determines the first SL-PRS based on the SL-PRS configuration associated with the first time window.

For example, the at least two time windows include a time window 1 and a time window 2, wherein the time window 1 is associated with an SL-PRS configuration 21, and the time window 2 is associated with an SL-PRS configuration 22. In the time window 1, the first terminal determines the SL-PRS 21 associated with the time window 1, and determines an SL-PRS based on the SL-PRS configuration 21. In the time window 2, the first terminal determines the SL-PRS 22 associated with the time window 2, and determines an SL-PRS based on the SL-PRS configuration 22.

In some embodiments, the association information includes the area and the time window; wherein at least two sets of areas and time windows are associated with different SL-PRS configurations. The first terminal contains at least two sets of areas and time windows, and different SL-PRS configurations associated with the at least two sets of areas and time windows; and the first association information includes a first area and a first time window. The first terminal determines the SL-PRS configuration associated with the first area and the first time window, and determines a first SL-PRS based on the SL-PRS configuration associated with the first area and the first time window.

For example, the at least two sets of areas and time windows include an area 1 and a time window 1, and an area 2 and a time window 2; wherein the area 1 and the time window 1 are associated with an SL-PRS configuration 31, and the area 2 and the time window 2 are associated with an SL-PRS configuration 32. The first terminal determines the SL-PRS configuration 31 associated with the area 1 and the time window 1, and determines an SL-PRS based on the SL-PRS configuration 31. The first terminal determines the SL-PRS configuration 32 associated with the area 2 and the time window 2, and determines an SL-PRS based on the SL-PRS configuration 32.

In some embodiments, each area corresponds to one or a plurality of time windows. In a case where one area corresponds to a plurality of time windows, the plurality of time windows within the area are associated with different SL-PRS configurations. For example, an area 1 corresponds to a time window 1 and a time window 2, wherein the area 1 and the time window 1 are associated with an SL-PRS configuration 31, and the area 1 and the time window 2 are associated with an SL-PRS configuration 33.

In some embodiments, each time window corresponds to one or a plurality of time windows. In a case where one time window corresponds to a plurality of areas, the plurality of areas within the time window are associated with different SL-PRS configurations. For example, a time window 1 corresponds to an area 1 and an area 2, the area 1 and the time window 1 are associated with an SL-PRS configuration 31, and the area 2 and the time window 1 are associated with an SL-PRS configuration 34.

In some embodiments, the area in the association information is represented by at least one of: a radio access network (RAN)-based notification area (RNA); a tracking area (TA); a synchronization signal and physical broadcast channel (PBCH) block (SSB); or a cell.

In some embodiments, the cell includes at least one of a primary cell (Pcell) or a secondary cell (Scell).

In some embodiments, the SL-PRS includes: a set of SL-PRS containing at least two SL-PRSs; or an assistance message containing at least two SL-PRSs. Exemplary, the first terminal determines the first SL-PRS from set of SL-PRS associated with the first association information; or determines the first SL-PRS from the at least two SL-PRSs contained in the assistance message associated with the first association information.

The first terminal is a sensing signal receiver terminal. Optionally, the first terminal may also be a sensing initiator device or a sensing responder device.

In step 602, the first terminal performs a sensing measurement via the first SL-PRS based on the first association information.

The first terminal performs the sensing measurement via the first SL-PRS on a sidelink based on the first association information. Exemplary, the first terminal receives and measures the first SL-PRS on the sidelink based on the first association information.

In some embodiments, the first association information includes the first area; and upon determining the first SL-PRS associated with the first area, the first terminal performs the sensing measurement via the first SL-PRS within the first area.

In some embodiments, the first association information includes a first time window; and upon determining the first SL-PRS associated with the first time window, the first terminal performs the sensing measurement via the first SL-PRS within the first time window.

In some embodiments, the first association information includes the first area and the first time window; and upon determining the first SL-PRS associated with the first area and the first time window, the first terminal performs the sensing measurement via the first SL-PRS transmitted within the first area within the first time window.

In other words, the first SL-PRS associated with the first area and/or the first time window is valid within the first time area and/or the first time window, such that the first SL-PRS is detectable by the first terminal. That is, the first SL-PRS associated with the first area is valid within the first area, such that the first SL-PRS is detectable by the first terminal; or the first SL-PRS associated with the first time window is valid within the first time window, such that the first SL-PRS is detectable by the first terminal. Alternatively, in the first time window, the first SL-PRS associated with the first area and the first time window is valid within the first area, such that the first SL-PRS is detectable by the first terminal.

Exemplary, the first SL-PRS is transmitted by an anchor terminal. The anchor terminal may be an RSU; or another terminal moving in the same direction as the first terminal. In this context, the other terminal may be of the same type as the first terminal. For example, both the first terminal and the anchor terminal are vehicle-mounted terminals. Alternatively, the other terminal may also be of a different type from the first terminal. For instance, the first terminal is the vehicle-mounted terminal, and the other terminal is a smartphone.

In some embodiments, the SL-PRS configuration further includes: an anchor terminal identifier, wherein at least two SL-PRSs are associated with different anchor terminals. That is, different SL-PRS are associated with different anchor terminals.

The first SL-PRS is transmitted by the anchor terminal associated with the first SL-PRS. Exemplary, subsequent to determining the first SL-PRS associated with the first association information, the first terminal determines the anchor terminal associated with the first SL-PRS, and receives the first SL-PRS transmitted by the anchor terminal associated with the first SL-PRS based on the first association information. For example, the first SL-PRS is received from the anchor terminal associated with the first SL-PRS within the first time window. As another example, within the first time window, the first SL-PRS is received from the anchor terminal associated with the first SL-PRS within the first area.

In summary, the method for sensing measurement according to the embodiments of the present disclosure allows the first terminal to determine, upon entering one area and/or one time window, the first SL-PRS associated with the first association information based on an association relationship between at least two pieces of association information and different SL-PRS configurations. By performing sensing measurement via the first SL-PRS regarding the area and/or the time window in the first association information, the sensing measurement may be performed via different SL-PRS upon entering different areas and/or different time windows. As a result, the first terminal achieves effective sensing measurements in different areas and/or time windows by autonomously selecting the appropriate SL-PRS. This eliminates the need to request SL-PRS configurations from the network, thereby significantly reducing signaling interaction between the first terminal and the network, and lowering the latency of the wireless sensing service.

In some embodiments, the at least two pieces of association information, and the different SL-PRS configurations associated with the at least two pieces of association information are predefined. Alternatively, the at least two pieces of association information, and the different SL-PRS configurations associated with the at least two pieces of association information are pre-configured by a network device.

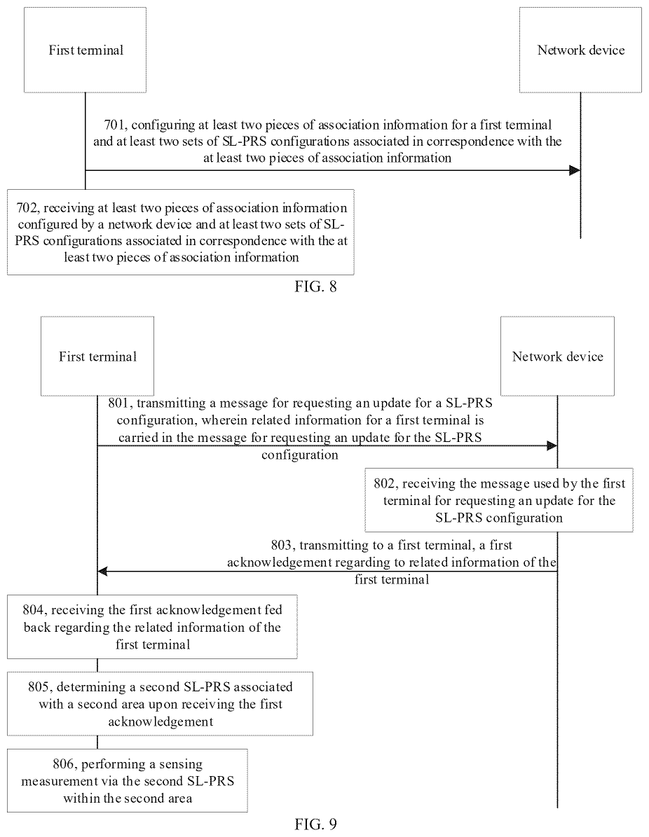

As illustrated in FIG. 8, the association information and the SL-PRS configuration associated with the association information are configured by the network device for the first terminal. The configuration method includes the following steps:

In step 701, the network device configures at least two pieces of association information with at least two sets of SL-PRS configurations associated with the at least two pieces of association information.

The at least two pieces of association information are associated with different SL-PRS configurations, and each of the at least two pieces of association information includes at least one of an area or a time window. Each piece of association information is associated with their corresponding SL-PRS configuration.

In some embodiments, the association information includes the area, and at least two areas are associated with different SL-PRS configurations.

In some embodiments, the association information includes the time window, and at least two time windows are associated with different SL-PRS configurations.

In some embodiments, the association information includes the area and the time window, and at least two sets of areas and time windows are associated with different SL-PRS configurations. Exemplary, each area corresponds to one or a plurality of time windows. In a case where one area corresponds to a plurality of time windows, the plurality of the time windows within the area are associated with different SL-PRS configurations. Exemplarily, each time window corresponds to one or a plurality of areas. In a case where one time window corresponds to a plurality of areas, the plurality of areas within the area are associated with different SL-PRS configurations.

In some embodiments, the area in the association relationship is represented by at least one of: an RNA; a TA; an SSB; or a cell.

In some embodiments, the SL-PRS configuration includes: an SL-PRS set containing at least two SL-PRSs; or an assistance message containing at least two SL-PRS.

In some embodiments, the SL-PRS configuration further includes: an anchor terminal identifier associated with the SL-PRS, wherein at least two SL-PRS are associated with different anchor terminals. Exemplary, the SL-PRS configuration further includes: geolocation information of the anchor terminal associated with the SL-PRS.

In some embodiments, the SL-PRS configuration further includes at least one of: a wireless SL-PRS configuration; an SL-PRS system frame number (SFN) offset; an NR-absolute radio frequency channel number (NR-ARFCN); an SL-PRS resource set or SL-PRS resource ID;
an SL-PRS periodicity-and-resource set slot offset; an SL-PRS resource repetition factor;
an SL-PRS resource time gap; an SL-PRS symbol number; an SL-PRS muting option 1; an SL-PRS muting option 2; an SL-PRS resource power; or an SL-PRS resource list.

In some embodiments, the wireless SL-PRS configuration includes at least one of: a subcarrier spacing; a resource bandwidth; a start physical resource block (start PRB); a start position of a start frequency reference point (point A); a comb size; or a cyclic prefix.

The cyclic prefix may be normal or extended.

Illustrative examples of the field for each of the above configurations are provided.
An nr-SL-PRS-ResourceSetID field indicates an SL-PRS resource set ID, which is used to identify the SL-PRS resource ID of a transmission and receiving point (TRP) on all frequency layers.
An sl-PRS-Periodicity-and-ResourceSetSlotOffset field indicates a periodicity of an SL-PRS allocation in slots configured for each SL-PRS resource set, and the slot offset for the TRP of the configured SL-PRS resource set (i.e., the slot in which the first SL-PRS resource of the SL-PRS resource set occurs) relative to a SFN #0 slot #0.
An sl-PRS-ResourceRepetitionFactor field indicates a number of repetition of each SL-PRS resource in a single instance of an SL-PRS resource set, and it is applied to all resources of the SL-PRS resource set. Enumerated values n2, n4, n6, n8, and n32, corresponds to 2, 4, 6, 8, 16, and 32 resource repetitions, respectively. In a case where this field is absent, a value of sl-PRS-ResourceRepetitionFactor is 1 (i.e., no resource repetition).
An sl-PRS-ResourceTimeGap field indicates an offset in slots between two repeated instances of one SL-PRS resource that correspond to the same SL-PRS resource ID within a single instance of the SL-PRS resource set. A duration spanned by one SL-PRS resource set containing the repeated SL-PRS resource should not exceed the SL PRS periodicity.
An sl-PRS-NumSymbols field indicates a number of symbols occupied by each SL-PRS resource in the slot.
An sl-PRS-mutingOption1 field indicates a muting configuration for the SL-PRS of the TRP of muting option 1, and includes the following subfields:
   sl-prs-MutingBitRepetitionFactor indicating a number of consecutive instances of the SL-PRS resource set corresponding to a single bit of the nr-option-muting bitmap. Enumerated values n1, n2, n4, and n8 corresponds to 1, 2, 4, and 8 consecutive instances, respectively. In a case where this field is absent, a value of dl prs MutingBitRepetitionFactor is n1.
   nr-option1-muting defining a bitmap of the time positions for transmitting (value ‘1’) or not transmitting (value ‘0’) the SL-PRS resource for one SL-PRS resource set.

In a case where this field is absent, the TRP does not use the muting option 1
An sl-PRS-mutingOption2 field indicates a muting configuration for the SL-PRS of TRP of muting option 2, and includes the following subfields:
   nr-option2-muting defining a bitmap of the time positions for transmitting (value ‘1’) or not transmitting (value ‘0’) the SL-PRS resource. Each bit of the bit map corresponds to a single repetition of the SL-PRS resource within one instance of one SL-PRS resource set. The size of this bitmap should be the same as a value of SL-PRS resource repetitions factor.

In a case where this field is absent, the TRP does not use the muting option 2.
An sl-PRS-ResourcePower field indicates an average EPRE (Energy Per Resource Element, RE being the smallest unit of the resource grid) in dBm (decibels in milliwatts) carrying PRS resource elements for a PRS transmission. The UE assumes a constant EPRE for all REs of a given SL-PRS resource.
An sl-PRS-Sequence ID field indicates a sequence ID used to initialize a pseudo-random generator.
An sl-PRS-CombSizeN-andReOffset field indicates a resource element spacing of each symbol of the SL-PRS resource, and a resource element offset of a first symbol in a frequency domain of the SL-PRS resource. All SL-PRS resource sets belonging in a same positioning frequency layer have a same comb size value. The RE offset in relation of the first symbol in a frequency domain of the SL-PRS resource defines the relative offset of the following symbol. A comb size configuration should be aligned with the comb size configuration for the frequency layer.
An sl-PRS-ResourceSlotOffset field indicates a start slot of the SL-PRS resource relative to a corresponding SL-PRS resource set slot offset.
An sl-PRS-ResourceSymbolOffset field indicates a start symbol of the SL-PRS resource within a slot determined by the SL PRS Resource Slot Offset.
An sl-PRS-QCL-Info (Quasi-CoLocation Information) field indicates a QCL indication of other SL reference signals used for a serving cell and neighboring cells, and includes the following subfields:
   ssb indicating SSB information of a QCL source, and including the following field:
      pci (physical cell identifier) indicating a physical cell ID of the cell configured as the SSB of an SL-PRS reference signal. The UE acquires an SSB configuration of the SSB configured as a source reference signal of the DL-PRS by indexing an nr SSB Config field with the physical cell identifier.
      ssb-Index indicating an index of the SSB configured as the source reference signal of the SL-PRS.
      rs-Type indicating a type of QCL.
      sl-PRS indicating PRS information used for a QCL source reference signal, and including the following subfields:
      qcl-SL-PRS-ResourceID indicating an SL-PPS resource ID of the SL-PRS resource used as the source reference signal.
      qcl-SL-PRS-ResourceSetID indicating the SL-PPS resource set ID of the SL-PRS resource set used as a source reference signal.
A qcl-SL-PRS-ResourcePrioritySubset field provides a subset of the SL-PRS resource,
   wherein the subset is associated with the nr SL PRS resource ID, and is used to report the purpose of the priority of an SL AoD. This field is only suitable for the SL-Angle of departure (AoD) positioning method, and should be ignored for an SL-Time Difference of Arrival (ToD) as well as a multi-round trip time (RTT) positioning method.

Exemplary, the network device configures the SL-PRS configuration associated with at least two pieces of association information via at least one of the above fields.

In step 702, the first terminal receives at least two pieces of association information configured by the network device with at least two sets of SL-PRS configurations associated in correspondence with the at least two pieces of association information.

In some embodiments, the first terminal receives at least two pieces of association information initially configured by the network device with at least two sets of SL-PRS configurations associated in correspondence with the at least two pieces of association information; or the first terminal receives at least two pieces of association information reconfigured by the network device with at least two sets of SL-PRS configurations associated in correspondence with the at least two pieces of association information.

In summary, the pre-configuration method according to the embodiments of the present disclosure allows the first terminal to determine, upon entering the first area and/or the time window, the SL-PRS for sensing measurement based on the SL-PRS configuration associated with the pre-configured area and/or time window, by pre-configuring at least two pieces of association information with different SL-PRS configurations associated with the at least two pieces of association information. In this way, the network device does not need to request the SL-PRS configurations from the network, reducing signaling interaction between the first terminal and the network in different areas and/or time windows, and lowering the latency of the wireless sensing service.

In a scenario where the association information is the area, upon leaving a first area and entering a second area, the first needs to determine a second SL-PRS for sensing measurement based on an association relationship between SL-PRS configuration and the area, to perform a sensing measurement via the second SL-PRS.

Upon entering the second area, the first terminal also requests an update for the SL-PRS configuration before performing a sensing measurement via the second SL-PRS.

In some embodiments, the first terminal requests the network device for an update for the SL-PRS configuration to request the network device to coordinate the operation of an anchor terminal in the first and/or the second area.

In some other embodiments, the first terminal requests the network device for an update for the SL-PRS configuration to request the network device to update the SL-PRS configuration associated with the second area.
In the case of requesting the network device to coordinate the operation of the anchor terminal, an interaction process between the first terminal and the network device includes:
transmitting a request for an update for the SL-PRS configuration by the first terminal to the network device, wherein related information of the first terminal is carried by the message for requesting the update for the SL-PRS configuration, i.e., upon entering the second area, the first terminal reports the related information of the first terminal.

In some embodiments, the related information of the first terminal includes at least one of: a location of the first terminal, such as a real-time positioning information of the first terminal; or an area information of the second area, such as an area identifier of the second area, wherein the second area is the area entered by the first terminal upon leaving the first area; or the information of a second SL-PRS to be measured by the first terminal, for example, a configuration for the second SL-PRS, and an identifier of the second SL-PRS, wherein the second SL-PRS is the SL-PRS associated with the second area.

In response to the request for the update for the SL-PRS configuration, the first terminal may receive feedback information based on the related information of the first terminal, or may not receive feedback information based on the related information the first terminal. Using the first terminal reporting the related information to the network device as an example, two cases are described as follows.

For a first case, FIG. 9 illustrates a sensing measurement process performed by the first terminal within the second area according to some embodiments of the present disclosure. The sensing measurement process includes the following steps.

In step 801, the first terminal transmits a message for requesting an update for the SL-PRS configuration, wherein the related information of the first terminal is carried by the message for requesting the update for the SL-PRS configuration.

Upon entering the second area, the first terminal determines the related information of the first terminal and reports the related information to the network device. For example, upon entering the second area, the first terminal determines its own location, and reports its own location to the network device. As another example, upon entering the second area, the first terminal reports the area information of the second area to the network device. As another example, upon entering the second area, the first terminal determines the second SL-PRS associated with the second area based on the association relationship between the area and the SL-PRS configuration, and reports the second SL-PRS information to the network device.

In some embodiments, the message for requesting the update for the SL-PRS configuration includes an SL-PRS configuration update request, and the related information of the terminal is carried by the SL-PRS configuration update request. Exemplary, the first terminal transmits the SL-PRS configuration update request, and the SL-PRS configuration update request carries the related information of the first terminal.

In step 802, the network device receives the message for requesting the update for the SL-PRS configuration used by the first terminal.

The network device acquires the related information of the first terminal carried by the message for requesting the update for the SL-PRS configuration.

The related information of the first terminal is reported by the first terminal upon entering the second area. Exemplary, the related information is reported upon the first terminal leaving the first area and entering the second area.

In some embodiments, the network device receives the SL-PRS configuration update request transmitted by the first terminal.

In step 803, the network device transmits a first acknowledgment to the first terminal based on the related information of the first terminal.

The first acknowledgment is used to trigger the first terminal to perform a sensing measurement via the second SL-PRS associated with the second area.

In some embodiments, the first acknowledgment is carried in an SL-PRS configuration update acknowledgment. Exemplary, the network device acquires the related information of the first terminal from the SL-PRS configuration update acknowledgment; and based on the related information of the first terminal, the network device transmits the SL-PRS configuration update acknowledgment, wherein the first acknowledgment is carried in the SL-PRS configuration update acknowledgment.

In step 804, the first terminal receives the first acknowledgment fed back based on the related information of the first terminal.

In step 805, the first terminal device determines the second SL-PRS associated with the second area upon receiving the first acknowledgment.

At least two areas are associated with different SL-PRS configurations. The first terminal contains at least two areas, and different SL-PRS configurations associated with the at least two areas; the first terminal determines the second SL-PRS associated with the second area in the at least two areas. Exemplary, the first terminal determines the SL-PRS configuration associated with the second area, and determines the second SL-PRS based on the SL-PRS configuration associated with the second area.

In some embodiments, the area in the associated related information is represented using at least one of: an RNA; a TA; an SSB; or a cell.

In some embodiments, the SL-PRS configuration includes: an SL-PRS set containing at least two SL-PRSs; or an assistance message containing at least two SL-PRSs. Exemplary, the first terminal determines the second SL-PRS from the SL-PRS set associated with the second area; or determines the second SL-PRS from the at least two SL-PRS in the assistance message associated with the second area.

In step 806, the first terminal performs a sensing measurement via the second SL-PRS within the second area.

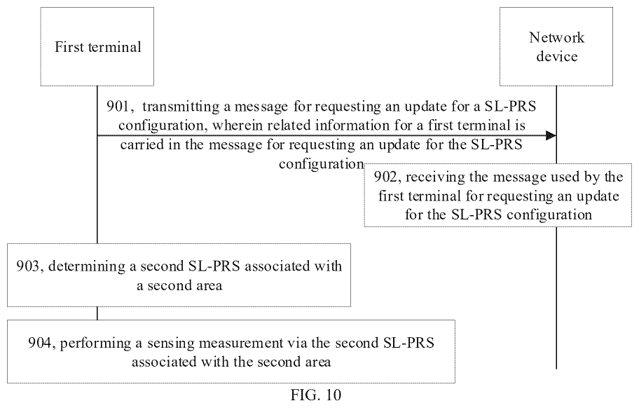

For the second case, FIG. 10 illustrates a sensing measurement process performed by the first terminal within the second area according to some embodiments of the present disclosure. The sensing measurement process includes the following steps.

In step 901, the first terminal transmits a message for requesting an update for the SL-PRS configuration, wherein related information of the first terminal is carried by the message for requesting the update for the SL-PRS configuration.

Upon entering the second area, the first terminal determines the related information of the first terminal and reports the related information to the network device. For example, upon entering the second area, the first terminal determines its own location, and reports its own location to the network device. As another example, upon entering the second area, the first terminal reports the area information of the second area to the network device. As another example, upon entering the second area, the first terminal determines the second SL-PRS associated with the second area based on the association relationship between the area and the SL-PRS configuration, and reports the second SL-PRS information to the network device.

In some embodiments, the message for requesting the update for the SL-PRS configuration includes an SL-PRS configuration update request, and the related information of the terminal is carried by the SL-PRS configuration update request. Exemplary, the first terminal transmits the SL-PRS configuration update request, and the SL-PRS configuration update request carries the related information of the first terminal.

In step 902, the network device receives a message for requesting an update for the SL-PRS configuration.

The network device acquires the related information of the first terminal carried in the message for requesting the update for the SL-PRS configuration.

The related information of the first terminal is reported by the first terminal upon entering the second area. Exemplary, the related information of the reported by the first terminal upon leaving the first area and subsequently entering the second area.

In some embodiments, the network device receives the SL-PRS configuration update request transmitted by the first terminal.

In step 903, the first terminal determines the second SL-PRS associated with the second area.

At least two areas are associated with different SL-PRS configurations. The first terminal contains at least two areas, and different SL-PRS configurations associated with the at least two areas. The first terminal determines the second SL-PRS associated with the second area in the at least two areas. Exemplary, the first terminal determines the SL-PRS configuration associated with the second area, and determines the second SL-PRS based on the SL-PRS configuration associated with the second area.

In some embodiments, the area in the associated related information is represented using at least one of: an RNA; a TA; an SSB; or a cell.

In some embodiments, the SL-PRS configuration includes: an SL-PRS set containing at least two SL-PRSs; or an assistance message containing at least two SL-PRSs. Exemplary, the first terminal determines the second SL-PRS from the SL-PRS set associated with the second area; or determines the second SL-PRS from the at least two SL-PRS in the assistance message associated with the second area.

In step 904, the first terminal performs a sensing measurement via the second SL-PRS within the second area.

Exemplary, in the two embodiments illustrated in FIG. 9 and FIG. 10, the network device may, upon reporting the related information of the first terminal, perform at least one of: initiating the second SL-PRS associated with the second area.
initiating a transmission of the second SL-PRS.
controlling the anchor terminal within the second area to enter an operating state. or
controlling the anchor terminal associated with the second SL-PRS to enter an operating state.

The operating state refers to an operating state participating in a sensing measurement with the second SL-PRS signal.

Exemplary, upon receiving the related information of the first terminal, the network device transmits first indication information to the anchor terminal within the second area based on the related information of the first terminal; or upon receiving the related information of the first terminal, the network device transmits first indication information to the anchor terminal associated with the second SL-PRS. The first indication information is used to instruct the anchor terminal to enable the second SL-PRS associated with the second area; and/or to instruct the anchor terminal to initiate the transmission of the second SL-PRS; and/or to instruct the anchor terminal to enter the operating state.

The network device contains at least two areas that are predefined or pre-configured for the first terminal, and the SL-PRS configuration associated with the at least two areas. The network device determines that the first terminal is located in the second area based on the related information of the first terminal; and transmits the first indication information to the anchor terminal in the second area. Alternatively, the network device determines that the first terminal is located in the second area based on the related information of the first terminal; determines the second SL-PRS associated with the second area; determines the anchor terminal associated with the second SL-PRS; and transmits the first indication information to the anchor terminal associated with the second SL-PRS.

In some embodiments, the anchor terminal contains at least two areas that are predefined or pre-configured for the first terminal, and the SL-PRS configuration associated with the at least two areas. In such a case, a location of the first terminal or an area indicator of the second area is carried by the first indication information, and the second SL-PRS associated with the second area is determined based on the location of the first terminal or the area indicator of the second area.

In some embodiments, the anchor terminal does not contain at least two areas that are predefined or pre-configured for the first terminal, and the SL-PRS configuration associated with the at least two areas. In such a case, information of the second SL-PRS can be carried by the first indication information, and the second SL-PRS is determined based on the information of the second SL-PRS.

Exemplary, the network device further receives a third acknowledgment transmitted by the anchor terminal in response to the first indication information, wherein the third acknowledgment is used to report to the network device that the anchor terminal has enabled the second SL-PRS associated with the second area.

In some other embodiments, upon receiving the related information of the first terminal the network device may perform at least one of: deactivating the first SL-PRS associated with the first area; terminating the transmission of the first SL-PRS; controlling the anchor terminal within the first area to terminate operation; or controlling the anchor terminal associated with the first SL-PRS to terminate operation.

The term “terminate operation” refers to a termination of a sensing measurement operation by the first SL-PRS signal.

Exemplary, upon receiving the related information of the first terminal, the network device transmits a second acknowledgment to the anchor terminal in the first area, or upon receiving the related information of the first terminal, the network device transmits the second acknowledgment to the anchor terminal associated with the first SL-PRS. Wherein the second acknowledgment is used to instruct the anchor terminal to deactivate the first SL-PRS associated with the first area; and/or to instruct the anchor terminal to terminate the transmission of the first SL-PRS; and/or to instruct the anchor terminal to terminate the operation.

The network device contains at least two areas that are predefined or pre-configured for the first terminal, and the SL-PRS configuration associated with the at least two areas. The network device determines the first area corresponding to the first terminal; and transmits a second indication information to the anchor terminal in the first area. Alternatively, the network device determines the first area corresponding to the first terminal based on the related information of the first terminal; determines the first SL-PRS associated with the first area; determines the anchor terminal associated with the first SL-PRS; and transmits the second indication information to the anchor terminal associated with the first SL-PRS.

In some embodiments, the anchor terminal contains at least two areas that are predefined or pre-configured for the first terminal, and the SL-PRS configuration associated with the at least two areas. In such a case, an area indicator of the first area is carried in the second indication information, and the first SL-PRS associated with the first area is determined based on the area indicator of the first area.

In some embodiments, the anchor terminal does not contain at least two areas that are predefined or pre-configured for the first terminal, and the SL-PRS configuration associated with the at least two areas. In such a case, an SL-PRS configuration for first SL-PRS is carried in the second indication information, and the first SL-PRS is determined based on the SL-PRS configuration for the first SL-PRS.

In some embodiments, the related information of the first terminal may also include at least one of: information of the first area or information of the first SL-PRS.

Exemplary, the network device may determine the anchor terminal associated with the first SL-PRS within the first area based on an indicator of the first area or the information of the first SL-PRS; for example, determining the anchor terminal associated with the first SL-PRS based on the information of the first SL-PRS, or determining the first SL-PRS associated with a first area indicator, based on the area indicator of the first area, and determining the anchor terminal associated with the first SL-PRS. Upon determining the anchor terminal associated with the first SL-PRS, the network device transmits the second indicator information to the anchor terminal associated with the first SL-PRS.

Exemplary, the network device may determine the anchor terminal within the first area based on the area indicator of the first area, and transmit the second indicator information to the anchor terminal within the first area.

In summary, in the method for sensing measurement according to the embodiments of the present disclosure, firstly, upon the first terminal leaving the first area and entering the second area, the first terminal reports its own position, and performs a sensing measurement via the second SL-PRS associated with the second area upon entering the second area, thereby ensuring an accuracy and effectiveness of an SL-PRS measurement.

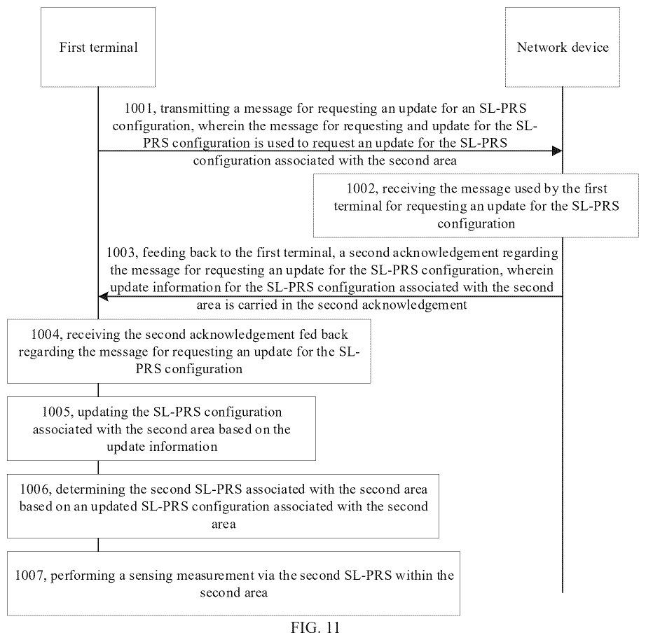

Secondly, the method may also enable the anchor terminal to perform the transmission of the second SL-PRS over the network device, supporting the first terminal to quickly switch from measuring the first SL-PRS to measuring the second SL-PRS, thereby lowering the latency of a wireless sensing service.
In a case where the network device updates the SL-PRS configuration associated with the second area, an interaction process between the first terminal and the network device is as illustrated in FIG. 11. The interaction process includes the following steps.

In step 1001, the first terminal transmits a message for requesting an update for the SL-PRS configuration, wherein the message for requesting the update for the SL-PRS configuration is used to request an update for the SL-PRS configuration associated with the second area.

In some embodiments, the message for requesting the update for the SL-PRS configuration includes an SL-PRS configuration update request. Exemplary, upon entering the second area, the first terminal transmits the SL-PRS configuration update request requesting to update the SL-PRS configuration associated with the second area.

In step 1002, the network device receives a message for requesting an update for the SL-PRS configuration used by the first terminal.

Exemplary, the message for requesting the update for the SL-PRS configuration is transmitted by the first terminal upon leaving the first area and entering the second area.

In step 1003, the network device feeds back a second acknowledgment in response to the message for requesting to update the SL-PRS configuration to the first terminal, wherein the second acknowledgment carries update information of the SL-PRS configuration associated with the second area.

In some embodiments, the second acknowledgment fed back in response the message for requesting the update for the SL-PRS configuration is carried in an SL-PRS configuration update acknowledgment. Exemplary, the network device feeds back the second acknowledgment to the first terminal in response to the message for requesting the update for the SL-PRS configuration, wherein the second acknowledgment is carried in the SL-PRS configuration update acknowledgment.

In some embodiments, update information is used to update part or all of the information in the SL-PRS configuration associated with the second area; and/or, the update information is used to be merged into the SL-PRS configuration associated with the second area. In other words, the update information is used to update part or all of the information in the SL-PRS configuration associated with the second area; or the update information is used to be merged into the SL-PRS configuration associated with the second area; or the update information contains two parts of information, wherein one part is used to update part or all of the information in the SL-PRS configuration associated with the second area, and another part is used to be merged into the SL-PRS configuration associated with the second area.

In step 1004, the first terminal receives the second acknowledgment fed back in response to the message for requesting the update for the SL-PRS configuration.

In some embodiments, the first terminal receives the SL-PRS configuration update acknowledgment, wherein the update information is carried in the SL-PRS configuration update acknowledgment. Subsequently, the first terminal acquires the update information from the SL-PRS configuration update acknowledgment.

In step 1005, the first terminal updates the SL-PRS configuration associated with the second area based on the update information.

The first terminal updates an existing SL-PRS configuration in the first terminal associated with the second area based the update information. Optionally, part or all of information in the SL-PRS configuration associated with the second area is updated based on the update information; and/or, the update information is merged into the SL-PRS configuration associated with the second area.

In other words, the first terminal updates part or all of the information in in the SL-PRS configuration associated with the second area. For example, a predefined or pre-configured SL-PRS configuration includes: an SL-PRS set containing at least two SL-PRSs; or an assistance message containing at least two SL-PRSs. An update for the SL-PRS may be the update for the SL-PRS set or the assistance message associated with the second area.

In some embodiments, the first terminal merges the update information into the SL-PRS configuration associated with the second area. For example, the predefined or preconfigured SL-PRS configuration does not include beam indication information (such as a beam direction, a beam size, and the like). Regarding the update for the SL-PRS, the beam indication information in the update information may be merged into the SL-PRS configuration associated with the second area.

In some embodiments, the update includes two parts of information: a first part of information and a second part of information. The first terminal updates part or all of the information in the SL-PRS configuration associated with the second area based on the first part of information, and merges the second part of information into the SL-PRS configuration associated with the second area.

For example, the predefined or pre-configured SL-PRS includes an anchor UE ID associated with the SL-PRS, but does not include the beam indication information. The first part of information in the update information is used to update the anchor UE ID, and the second part of information in the update information is used to update the beam indication information. The update for the SL-PRS configuration associated with the second area is performed based on the anchor UE ID, and the beam indication information is merged into the SL-PRS configuration associated with the second area.

In some embodiments, the beam indication information is dynamically determined based on a position where the first terminal enters the second area.

In some embodiments, the acknowledgment may indicate that the SL-PRS configuration associated with the second area is not to be updated.

In step 1006, the first terminal determines the second SL-PRS associated with the second area based on an updated SL-PRS configuration associated with the second area.

Exemplary, the first terminal determines the second SL-PRS from the SL-PRS set associated with the second area based on the updated SL-PRS configuration associated with the second area; or determines the second SL-PRS from the at least two SL-PRSs contained in the assistance message associated with the second area.

In step 1007, the first terminal performs a sensing measurement via the second SL-PRS within the second area.

In summary, in the sensing method according to the embodiments of the present disclosure, upon entering the second area and subsequently updating the SL-PRS configuration associated with the second area, the first terminal performs a sensing measurement via the second SL-PRS within the second area, thereby ensuring the accuracy and effectiveness of the SL-PRS measurement.

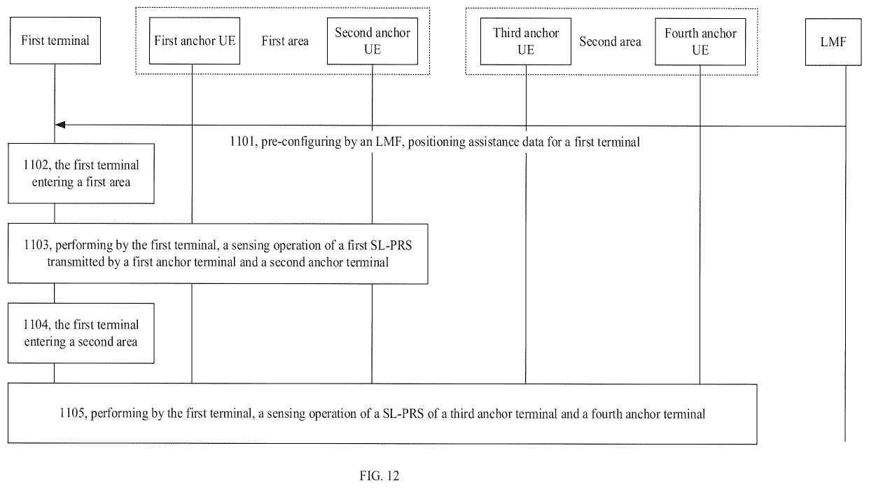

In some embodiments, upon leaving the first area and entering the second area, the first terminal performs a sensing measurement via the SL-PRS configuration and an anchor terminal different from those in the first area. Exemplary, as illustrated in FIG. 12, a sensing measurement process in this case is described hereinafter.

In step 1101, an LMF pre-configures positioning assistance data for the first terminal.

Exemplary, the positioning assistance data includes the SL-PRS configuration associated with at least two areas. The SL-PRS configuration includes the SL-PRS set containing at least two SL-PRSs; or includes the assistance message containing at least two SL-PRSs. The at least two SL-PRSs are further associated with different anchor terminals. Optionally, the positioning assistance data includes different anchor UE IDs associated with at least two SL-PRSs.

The at least two areas include a first area and a second area.

In step 1102, the first terminal enters the first area.

In step 1103, the first terminal performs a sensing operation for the first SL-PRS transmitted by a first anchor terminal and a second anchor terminal.

Upon entering the first area, the first terminal determines the first SL-PRS associated with the first area, and the first anchor terminal and the second anchor terminal associated with the first SL-PRS, and performs a sensing measurement for the first SL-PRS transmitted by the first anchor terminal and the second anchor terminal.

In some embodiments, within the first area, different first SL-PRSs are associated with the first anchor terminal and the second anchor terminal.

In step 1104, the first terminal enters the second area.

In step 1105, the first terminal performs a sensing operation for the first SL-PRS transmitted by a third anchor terminal and a fourth anchor terminal.

Upon entering the second area, the first terminal determines the second SL-PRS associated with the second area, and the third anchor terminal and the fourth terminal associated with the second SL-PRS, and performs a sensing measurement for the second SL-PRS transmitted by the third anchor terminal and the fourth anchor terminal.

In some embodiments, within the second area, different second SL-PRSs are associated with the third anchor terminal and the fourth anchor terminal.

In summary, in the method for sensing measurement according to the embodiments of the present disclosure, upon entering different areas, the first terminal may determine different SL-PRSs associated with different areas based on an association relationship between different SL-PRS configurations associated with at least two areas, and different anchor terminals associated with different SL-PRS, so as to perform sensing measurement of different anchor terminals in different areas, and to perform sensing measurement of multiple anchor terminals in the same area. As a result, the first terminal achieves effective sensing measurements in different areas and/or time windows by autonomously selecting the appropriate SL-PRS. This eliminates the need to request SL-PRS configurations from the network, thereby significantly reducing signaling interaction between the first terminal and the network, and lowering the latency of the wireless sensing service.

It should be understood that in each embodiment of the present disclosure, the network device is an access network device, for instance: a gNB; or a core network device, for instance: any one of a position management function such as a location management function (LMF), an access and mobility management function (AMF), or a sensing function (SF).

Upon completion of a sensing measurement, the first terminal reports a sensing result of the sensing measurement to the sensing initiator device. The sensing result includes but is not limited to information of at least one: a reference signal received power (RSRP), latency, Doppler shift, channel information, distance, velocity, orientation, and acceleration.

In summary, in the method for sensing measurement according to the embodiments of the present disclosure, a terminal may perform effective sensing measurement within different areas and/or time windows, while not needing to request an SL-PRS configuration from the network, reducing the signaling interaction between the first terminal and the network upon entering different areas, and lowering the latency of a wireless sensing service.

Hereinafter are apparatus embodiments of the present disclosure, which may be used to practice the method embodiments of the present disclosure. For details not disclosed in the apparatus embodiments of the present disclosure, reference may be made to the method embodiments of the present disclosure.

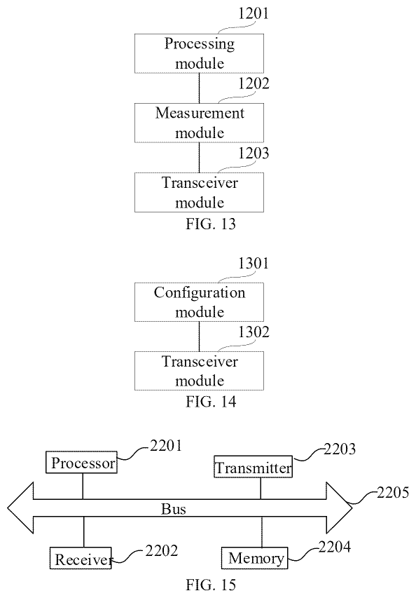

FIG. 13 illustrates a schematic block diagram of a sensing apparatus according to some embodiments of the present disclosure.

The sensing apparatus includes: a processing module 1201, adapted to determine a first SL-PRS associated with first association information with at least two pieces of association information associated with different SL-PRS configurations, and each of the at least two pieces of association information include at least one of an area or a time window; and a measurement module 1202, adapted to perform a sensing measurement via the first SL-PRS based on the first association information.

In some embodiments, the area is represented by at least one of: an RNA; a TA; an SSB; or a cell.

In some embodiments, the SL-PRS configuration includes: an SL-PRS set containing at least two SL-PRSs; or an assistance message containing at least two SL-PRSs.

In some embodiments, the SL-PRS configuration further includes: an anchor terminal indicator associated with the SL-PRS, wherein at least two SL-PRSs are associated with different anchor terminals.

In some embodiments, the first SL-PRS is transmitted by the anchor terminal associated with the first SL-PRS.

In some embodiments, the first association information includes a first area; the processing module 1201 is adapted to determine the first SL-PRS associated with the first area; and the measurement module 1202 is adapted to perform the sensing measurement via the first SL-PRS within the first area.

In some embodiments, the first association information includes a first time window; the processing module 1201 is adapted to determine the first SL-PRS associated with the first time window; and the measurement module 1202 is adapted to perform the sensing measurement via the first SL-PRS within the first time window.

In some embodiments, the first association information includes the first area and the first window; the processing module 1201 is adapted to determine the first SL-PRS associated with the first area and the first time window; and the measurement module 1202 is adapted to perform the sensing measurement via the first SL-PRS transmitted in the first area within the first time window.

In some embodiments, the apparatus further includes: a transceiver module 1203, adapted to receive the at least two pieces of association information configured by the network device, and at least two sets of SL-PRS configuration associated in correspondence to the at least two pieces of association information.

In some embodiments, the transceiver module 1203 is adapted to request an update for the SL-PRS configuration.

In some embodiments, a message for requesting an update for the SL-PRS configuration carries related information of a first terminal.

The related information of the first terminal includes at least one of: a position of the first terminal, area information of a second area, or information of a second SL-PRS to be measured by the first terminal. The second area is the area entered by the first terminal upon leaving the first area, and the second SL-PRS is the SL-PRS associated with the second area.

In some embodiments, the transceiver 1203 is adapted to receive a first acknowledgment fed back based on the related information of the first terminal, wherein the first acknowledgment is used to trigger the first terminal to perform a sensing measurement via the second SL-PRS associated with the second area.

In some embodiments, the message for requesting the update for the SL-PRS configuration includes an SL-PRS configuration update acknowledgment; and the first acknowledgment is carried in the SL-PRS configuration update acknowledgment.

In some embodiments, the message for requesting the update for the SL-PRS configuration is used to request an update for the SL-PRS configuration associated with the second area, wherein the second area is the area entered by the first terminal upon leaving the first areal.

The transceiver 1203, adapted to receive a second acknowledgment fed back in response to the message for requesting the update for the SL-PRS configuration, and the second acknowledgment carries update information for the SL-PRS configuration associated with the second area.

In some embodiments, the message for requesting the update for the SL-PRS configuration request includes an SL-PRS configuration update request; and the second acknowledgment is carried in the SL-PRS configuration update acknowledgment.

In some embodiments, the processing module 1201 is adapted to: update, based on an update information, part or all of information in the SL-PRS configuration associated with the second area; and/or merge the update information into the SL-PRS configuration associated with the second area.

In some embodiments, the SL-PRS configuration further includes at least one of: a wireless SL-PRS configuration; an SL-PRS system frame number (SFN) offset; an NR-absolute radio frequency channel number (NR-ARFCN); an SL-PRS resource set or SL-PRS resource ID; an SL-PRS periodicity-and-resource set slot offset; an SL-PRS resource repetition factor; an SL-PRS resource time gap; an SL-PRS symbol number; an SL-PRS muting option 1; an SL-PRS muting option 2; an SL-PRS resource power; or an SL-PRS resource list.

In some embodiments, the wireless SL-PRS configuration includes at least one of: a subcarrier spacing; a resource bandwidth; a start physical resource block (Start PRB); a start position of a start frequency reference point (point A); a comb size; or a cyclic prefix.

FIG. 14 illustrates a schematic block diagram of a sensing apparatus according to some embodiments of the present disclosure.

The sensing apparatus includes: a configuration module 1301, adapted to configure at least two pieces of association information with two sets of SL-PRS configurations associated with the corresponding at least two pieces of association information, wherein at least two pieces of association information are associated with different SL-PRS configurations, and each of the at least two pieces of association information includes at least one of an area or a time window.

In some embodiments, the area is represented using at least one of: an RNA; a TA; an SB; or a cell.

In some embodiments, the SL-PRS configuration includes: an SL-PRS set containing at least two SL-PRSs, or an assistance message containing at least two SL-PRSs.

In some embodiments, the SL-PRS configuration further includes: an anchor terminal indicator associated with the SL-PRS, wherein at least two SL-PRSs are associated with different anchor terminals.

In some embodiments, the apparatus further includes: a transceiver 1302, adapted to receive a message for requesting an update for the SL-PRS configuration from the first terminal.

In some embodiments, the message for requesting the update for the SL-PRS configuration carries related information of the first terminal.

The related information of the first terminal includes at least one of: a position of the first terminal, area information of the second area, or information of a second SL-PRS to be measured by the first terminal. The second area is the area entered by the first terminal upon leaving the first areal, and the second SL-PRS is the SL-PRS associated with the second area.

In some embodiments, the transceiver 1302 is adapted to transmit a first acknowledgment to the first terminal based on the related information of the first terminal, wherein the first acknowledgment is used to trigger the first terminal to perform a sensing measurement via the second SL-PRS associated with the second area.

In some embodiments, the message for requesting the update for the SL-PRS configuration includes an SL-PRS configuration update request; wherein the first acknowledgment is carried in the SL-PRS configuration update request.

In some embodiments, the transceiver 1302 is adapted to transmit first indication information to an anchor terminal within the second area based on the related information of the first terminal, and the first indication information is used to instruct the anchor terminal to enable the second SL-PRS associated with the second area; and the transceiver 1302 is adapted to receive a third acknowledgment from the anchor terminal in response to the first indication information.

In some embodiments, the message for requesting the update for the SL-PRS configuration is used to request an update for the SL-PRS configuration associated with the second area, the second area is the area entered by the first terminal upon leaving the first area; and the transceiver 1302 is adapted to feed back a second acknowledgment to the first terminal in response to the message for requesting the update for the SL-PRS configuration, wherein the second acknowledgment carries update information for the SL-PRS associated with the second area.

In some embodiments, the message for requesting the update for the SL-PRS configuration includes the SL-PRS configuration update request; wherein the second acknowledgment is carried in the SL-PRS configuration update request.

In some embodiments, the update information is used to update part or all of the information in in the SL-PRS configuration associated with the second area; and/or the update information is used to be merged into the SL-PRS configuration associated with the second area.

In some embodiments the SL-PRS configuration includes at least one of: a wireless SL-PRS configuration; an SL-PRS system frame number (SFN) offset; an NR-absolute radio frequency channel number (NR-ARFCN); an SL-PRS resource set or SL-PRS resource ID; an SL-PRS periodicity-and-resource set slot offset; an SL-PRS resource repetition factor; an SL-PRS resource time gap; an SL-PRS symbol number; an SL-PRS muting option 1; an SL-PRS muting option 2; an SL-PRS resource power; or an SL-PRS resource list.

In some embodiments, the wireless SL-PRS configuration includes at least one of: a subcarrier spacing; a resource bandwidth; a start physical resource block (start PRB); a start position of a start frequency reference point (point A); a comb size; or a cyclic prefix.

It should be noted that the apparatus provided in the above embodiments is only described by way of example in terms of the division of functional modules when implementing its functions. In practice, the functions may be allocated to be completed by different functional modules as needed. That is, the internal structure of the device may be divided into different functional modules to complete part or all of the functions described above.

Regarding the apparatus in the above embodiments, the specific manner in which each module performs operations has been described in detail in the method embodiments and is be elaborated herein.

FIG. 15 is a schematic structural diagram of a communication device according to some embodiments of the present disclosure.

The communication device includes: a processor 2201, a receiver 2202, a transmitter 2203, a memory 2204, and a bus 2205.

The processor 2201 includes one or more processing cores. The processor 2201 performs various functional applications and information processing by running software programs and modules.

The receiver 2202 and the transmitter 2203 may be implemented as a transceiver, and the transceiver may be a communication chip.

The memory 2204 connects to the processor 2201 via the bus 2205. Exemplary, the processor 2201 may be implemented as a first IC chip, and the processor 2201 and the memory 2204 may be implemented together as a second IC chip. Each of the first IC chip and the second IC chip may be an application-specific integrated circuit (ASIC) chip.

The memory 2204 may be configured to store one or more computer programs, and the processor 2201 is configured to load and run the one or more computer programs to perform each process performed by the access point multi-link device in above method embodiments.

Additionally, the memory 2204 may be implemented by any type of transitory or non-transitory storage device or a combination thereof, and the transitory or non-transitory storage device includes but is not limited to: a random-access memory (RAM), a read-only memory (ROM), an erasable programmable read-only memory (EPROM), an electrically erasable programmable read-only memory (EEPROM), a flash memory or other solid-state storage devices, a compact disc read-only memory (CD-ROM), a high-density digital video disc (DVD) or other optical storage devices, a tape cassette, a magnetic tape, a disk storage or other magnetic storage devices.

Some embodiments of the present disclosure further provide a computer-readable storage medium storing one or more computer programs therein. The one or more computer programs, when loaded and run by a processor of a multi-link device, cause the multi-link device to perform the method for sensing measurement as described above.

Optionally, the computer-readable storage medium includes: a read-only memory (ROM), a random-access memory (RAM), a solid state drive (SSD), an optical disk, or the like. The RAM may include a resistance random-access memory (ReRAM) and a dynamic random-access memory (DRAM).

Some embodiments of the present disclosure further provide a chip. The chip includes programmable electric circuitry and/or one or more program instructions, wherein the chip, when running on a multi-link device, is configured to perform the method for sensing measurements as described above.

Some embodiments of the present disclosure further provide a computer program product or computer program. The computer program product or computer program includes one or more computer instructions, wherein the one or more computer instructions are stored in the computer-readable storage medium. The one or more computer instructions, when loaded and executed by a multi-link device from the computer-readable storage medium, cause the multi-link device to perform the method for sensing measurements as described above.

It should be understood that the term “indicate” in the embodiments of the present disclosure means the direct indication, indirect indication, or an associated relationship. For example, A indicating B means that A directly indicates B, for example, B is acquired by A; A indirectly indicates B, for example, A indicates C and B is acquired by C; A and B are associated.

In the description of the embodiments of the present disclosure, the term “corresponding” may indicate a direct or indirect correspondence between two items, or an association relationship between the two items, or a relationship between indication and being indicated, configuration and being configured, and the like.

The mentioned term “a plurality of” herein means two or more. The term “and/or” describes the association relationship between the associated objects, and indicates that three relationships may be present. For example, the phrase “A and/or B” means (A), (B), or (A and B). The symbol “/” generally indicates an “or” relationship between the associated objects.

In addition, serial numbers of the processes described herein only show an exemplary possible sequence of performing the processes. In some other embodiments, the processes may also be performed out of the numbering sequence, for example, two processes with different serial numbers are performed simultaneously, or two processes with different serial numbers are performed in a reverse order to the illustrated sequence, which is not limited in the present disclosure.

Those skilled in the art should understand that in one or more of the above embodiments, the functions described in the embodiments of the present disclosure may be implemented in hardware, software, firmware, or any combination thereof. The functions, when implemented in software, may be stored in a computer-readable medium or transmitted as one or more instructions or codes on a computer-readable medium. The computer-readable medium includes a computer storage medium and a communication medium, where the communication medium includes any medium that facilitates the transfer of a computer program from one place to another. The storage medium is any available medium that is accessible by a general-purpose or special-purpose computer.

Described above are merely exemplary embodiments of the present disclosure and are not intended to limit the present disclosure. Any modifications, equivalent substitutions, improvements and the like, made within the spirit and principle of the present disclosure should fall within the protection scope of the present disclosure.

1. A method for sensing measurement, performed by a first terminal, the method comprising:
determining a first sidelink positioning reference signal (SL-PRS) associated with first association information, wherein at least two pieces of association information are associated with different SL-PRS configurations, and each of the at least two pieces of association information comprises at least one of an area or a time window;
performing a sensing measurement via the first SL-PRS based on the first association information.

2. The method according to claim 1, wherein the area is represented by at least one of:
a radio access network (RAN)-based notification area (RNA);
a tracking area (TA);
a synchronization signal and physical broadcast channel (PBCH) block (SSB); or
a cell.

3. The method according to claim 1, wherein each of the SL-PRS configurations comprises:
an SL-PRS set containing at least two SL-PRSs; or
an assistance message containing at least two SL-PRSs.

4. The method according to claim 1, wherein each of the SL-PRS configurations further comprises:
an anchor terminal ID associated with an SL-PRS, wherein at least two SL-PRSs are associated with different anchor terminals; wherein the first SL-PRS is transmitted by the anchor terminal associated with the first SL-PRS.

5. The method according to claim 1, wherein:
the first association information comprises a first area and a first time window;
determining the first SL-PRS associated with the first association information comprises:
determining the first SL-PRS associated with the first area and the time window; and
performing the sensing measurement via the first SL-PRS based on the first association information comprises:
performing, within the first time window, the sensing measurement via the first SL-PRS transmitted within the first area.

6. The method according to claim 1, further comprising:
receiving at least two pieces of association information configured by a network device and at least two sets of SL-PRS configurations corresponding to the at least two pieces of association information.

7. The method according to claim 1, further comprising:
requesting an update for the SL-PRS configuration;
wherein a message for requesting the update for the SL-PRS configuration carries related information of the first terminal; and
wherein the related information of the first terminal comprises at least one of: a position of the first terminal, area information of a second area, and information of a second SL-PRS to be measured by the first terminal; wherein the second area is an area entered by the first terminal upon leaving the first area, and the second SL-PRS is an SL-PRS associated with the second area.

8. The method according to claim 7, further comprising:
receiving a first acknowledgment regarding the related information of the first terminal, wherein the first acknowledgment is used to trigger the sensing measurement by the first terminal using the second SL-PRS associated with the second area;
wherein a message for requesting the update for the SL-PRS configuration comprises an SL-PRS configuration update request; and the first acknowledgment is carried in an SL-PRS configuration update acknowledgment.

9. The method according to claim 6, wherein:
the message for requesting the update for the SL-PRS configuration is used to request an update for an SL-PRS configuration associated with a second area, wherein the second area is an area entered by the first terminal upon leaving a first area;
the method further comprises:
receiving a second acknowledgment in response to the message for requesting the update for the SL-PRS configuration, wherein the second acknowledgment carries update information for the SL-PRS configuration associated with the second area;
wherein the message for requesting the update for the SL-PRS configuration comprises an SL-PRS configuration update request; and the second acknowledgment is carried in an SL-PRS configuration update acknowledgment.

10. The method according to claim 9, further comprising:
updating, based on the update information, part or all of information associated with the second area in the SL-PRS configuration; and/or
merging the update information into the SL-PRS configuration associated with the second area.

11. A method for sensing measurement, performed by a network device, the method comprising:
configuring at least two pieces of association information for a first terminal with at least two sets of SL-PRS configurations corresponding to the at least two pieces of association information, wherein the at least two pieces of association information are associated with different SL-PRS configurations, and each of the at least two pieces of association information comprises at least one of an area or a time window.

12. The method according to claim 11, wherein the SL-PRS configuration comprises:
an SL-PRS set containing at least two SL-PRSs; or
an assistance message containing at least two SL-PRSs.

13. The method according to claim 11, further comprising:
receiving a message used by the first terminal to request an update for the SL-PRS configuration.

14. The method according to claim 13, wherein a message for requesting the update for the SL-PRS configuration carries related information of the first terminal;
wherein the related information of the first terminal comprises at least one of: a position of the first terminal, area information of a second area, and second SL-PRS information to be measured by the first terminal; the second area is the area entered by the first terminal upon leaving a first area, and the second SL-PRS is the SL-PRS associated with the second area.

15. The method according to claim 14, further comprising:
transmitting a first acknowledgment to the first terminal based on the related information of the first terminal, wherein the first acknowledgment is used to trigger sensing measurement by the first terminal using the second SL-PRS associated with the second area.

16. The method according to claim 15, wherein the message for requesting the update for the SL-PRS configuration comprises an SL-PRS configuration update request; and the first acknowledgment is carried in an SL-PRS configuration update acknowledgment.

17. The method according to claim 14, further comprising:
transmitting, first indication information to an anchor terminal within the second area based on the related information of the first terminal, wherein the first indication information is used to instruct the anchor terminal to enable the second SL-PRS associated with the second area;
receiving, in response to the first indication information, a third acknowledgment.

18. The method according to claim 11, wherein the SL-PRS configuration comprises at least one of:
a wireless SL-PRS configuration;
an SL-PRS SFN offset;
an NR-ARFCN;
an SL-PRS resource set ID or SL-PRS resource ID;
an SL-PRS periodicity-and-resource set slot offset;
an SL-PRS resource repetition factor;
an SL-PRS resource time gap;
an SL-PRS symbol number;
an SL-PRS muting option 2;
an SL-PRS muting option 2; or
an SL-PRS resource list.

19. The method according to claim 18, wherein the wireless SL-PRS configuration comprises at least one of:
a subcarrier spacing;
a resource bandwidth;
a start PRB;
a start position of a start frequency reference point (point A);
a comb size; or
a cyclic prefix.

20. A chip, comprising:
programmable electric circuitry and/or one or more program instructions, wherein the chip, when running on a device, is configured to determine a first sidelink positioning reference signal (SL-PRS) associated with first association information, wherein at least two pieces of association information are associated with different SL-PRS configurations, and each of the at least two pieces of association information comprises at least one of an area or a time window; and perform a sensing measurement via the first SL-PRS based on the first association information.
